(19) United States
(12) Patent Application Publication
(10) Pub. No.: US 2009/0038686 A1
(43) Pub. Date: Feb. 12, 2009

(54) Water tap

(76) Inventor: Su-Hsien Lin, Miaoli (TW)

Correspondence Address: BERLINER & ASSOCIATES, 555 WEST FIFTH STREET, 31ST FLOOR, LOS ANGELES, CA, 90013, US

(21) Appl. No.: 11/975,865

(22) Filed: Oct. 22, 2007

(30) Foreign Application Priority Data
Aug. 6, 2007 (TW) 096212858

(51) Int. Cl. F16K 17/36; F16K 21/00

(52) U.S. Cl. 137/39; 137/801

(57) ABSTRACT

The present invention provides a water tap including a main body; a decorative cap for covering the main body while exposing the cavity therefrom; a water control assembly; a fastening means for fastening the water control assembly and the decorative cap to the main body; and a rotation-driving member adapted to connect with the water control assembly, thereby providing for a durable cap assembly structure that is easy to manufacture and process at low cost and is easily assembled, thus overcoming the drawbacks of prior techniques.

### BACKGROUND OF THE INVENTION

1. Field of the Invention

The present invention relates to a water control apparatus, and more particularly, to an improved water tap structure.

2. Description of Prior Art

Water taps are one of the most frequently used devices in daily life. Most conventional taps in the early days were made of copper material and were formed by heating copper to liquify it and pouring the heated copper liquid into tap molds of the desired shapes. Subsequently, an improved technique of forged cast mold processing has emerged and gradually replaced the conventional molding process, wherein the improved technique is accomplished by heating and pressing copper blocks to take shape and form the desired tap body.

The forged casting process has several disadvantages in that it requires the subsequent processing of grounding and polishing after detachment of the molded taps, and it also requires many sets of pressing molds for welding each of the components, increasing processing costs and complixities in the manufacturing and assembly processes. Also, each component has to be connected together by a connecting technique in the assembly process of the water tap, and if the components are connected by welding, inevitably the appearance of the tap would have a color difference between different components as a result of the different processing steps, undesirably affecting the aesthetics of the tap. In addition, the copper-made taps are also disadvantageous due to their heavy weight and due to the cost of copper, which continues to escalate in cost.

In view of the foregoing drawbacks of the prior techinques, Taiwanese Utility Model Patent Nos. M314814 and 1268321 have disclosed water taps having part of the components made of plastic. Taiwanese Utility Model Patent No. M314814 discloses an integrally formed water control assembly by plastic injection molding that requires the use of extra components for connecting and rigidly securing the water control assembly, complicating the assembly process and increasing the cost as a result. Similarly, the water tap disclosed in Taiwanese Utility Model Patent No. 1268321 also requires separate assembly of each of its components and thus is unable to remedy the defects of the Taiwanese Utility Model Patent Nos. M314814. Moreover, the copper-made water control assembly of the prior art typically employs a cylindrical cover for covering the core shaft and other components therein, which, due to the inherent property of copper and a height of merely 0.75 mm existing between the connecting point of the core shaft and the cylinder cover, the washer of the core shaft is prone to wear down or be damaged from the repetitive actions of opening and closing the water tap, thereby resulting in water leakage, usually from the front plane of the tap.

Moreover, for water-saving purposes, a water-preserving valve or regulator is often employed in the water-discharging outlet for regulating and adjusting the discharge of water. The regulator typically comprises a regulator head and a regulator net disposed inside of the head, and thus it is necessary to use a tool such as a wrench or coin in order to manually rotate and bring the regulator into operation, and, also, the regulator net is known to easily become clogged and lose its efficacy, causing great inconvenience in installation and usage.

As such, it is desirable to provide an improved water tap assembly structure capable of overcoming the drawbacks of the prior art described above.

### SUMMARY OF THE PRESENT INVENTION

In light of the drawback associated with the conventional techniques as described above, the primary objective of the present invention is to provide a water tap that can be processed easily.

Another objective of the present invention is to provide a water tap that can be easily assembled and installed.

Another objective of the present invention is to provide a water tap that can be easily manufactured at low cost.

Another objective of the present invention is to provide a water tap that can be used over a relatively long time and has long lifespan.

In accordance with the foregoing and other objectives, the present invention provides a water tap including: a main body comprised of at least a passageway, a water inlet port and a water outlet port respectively disposed on the two ends of the passageway, a first positioning portion disposed in the passageway, a first coupling portion disposed at a position away from the first positioning portion and above the main body, and a receiving portion disposed at a position between the first positioning portion and the first coupling portion; a decorative cap for covering the main body and exposing the cavity; a water control assembly comprised of a core shaft disposed in the cavity and having a first limiting portion, a first water control member configured to correspond to the first limiting portion, and a second water control member rigidly disposed on the bottom of the first water control member and corresponding to the first positioning portion; a fastening means comprised of a second coupling portion corresponding to the first coupling portion, a second limiting portion connected to the second coupling portion, and a penetrable portion for allowing the core shaft to pass therethrough, wherein the second limiting portion is adapted to restrict movement of the core shaft in the penetrable portion and concurrently enable the water control assembly and the decorative cap to be fastened to the main body; and a rotation-driving member configured to sleeve the core shaft and cover on the cavity.

In one aspect of the present invention, the main body may be, for example, an integrally formed plastic and steel injection tap body, and the decorative cap may be a cap structure made of plastic, or it can also be formed integrally, thereby eliminating the difficulties in processing, as well as reducing material and production costs due to the reduction in manufacturing processing as encountered in prior techniques while still maintaining rigidity of the tap structure.

In comparison to prior techniques, the water tap of the present invention employs a fastening means for fastening the water control assembly and the decorative cap to the main body, thereby simplifying assembly steps and decreasing assembly costs as a result. Further, the water control assembly of the present invention is characterized in that the core shaft and the first and second water control members are each separately installed. The first and second water control members may be ceramic planar bodies having high rigidness to enhance the structural strength and rigidity and wear endurance, thereby overcoming the defect of easy breaking due to the poor structural rigidity, and moreover, the first and second water control members can be fastened directly to the main body without requiring additional means or components for fastening purposes.

Additionally, the water tap of the present invention as described above may further include a decorative panel and a regulator disposed on the body at a position away from the decorative panel. The decorative panel may be installed at a rear end of a general straight bolt type faucet to prevent possible damage to the wall during installation and increase the aesthetics. The regulator may be integrally formed with a plurality of water-flowing portions and turning-assist portions disposed on the outer periphery thereof. The water-flowing portion is adapted to replace and eliminate the use of the conventional rectifying net that has to be separately installed in the prior art, so as to solve the drawback of the conventional rectifying net that is known to become clogged. The turning-assist portion is adapted to facilitate and assist in manual rotation of the regulator during installation, thereby eliminating the use of a rotating tool for the regulator in the prior art. Further, the body may be provided with a cap member at an end thereof, and also a leak-proof member may be disposed between the cap member and an end of the passageway, such that the decorative cover may fasten the cap member and the leak-proof member on one side of the body when it covers the body, thereby preventing water from leaking at the front plane of the tap.

### BRIEF DESCRIPTION OF THE DRAWINGS

FIG. 1 is an exploded perspective view showing a first embodiment of the water tap in accordance with the present invention.

FIG. 2 is an enlarged view of FIG. 1;

FIG. 3 is an enlarged view of FIG. 1;

FIG. 4 is an enlarged view of FIG. 1;

FIG. 5 is an enlarged view of FIG. 1;

FIG. 6 is an enlarged view of FIG. 1; and

FIG. 7 is an exploded perspective view showing another embodiment of the water tap in accordance with the present invention.

### DETAILED DESCRIPTION OF THE PREFERRED EMBODIMENTS

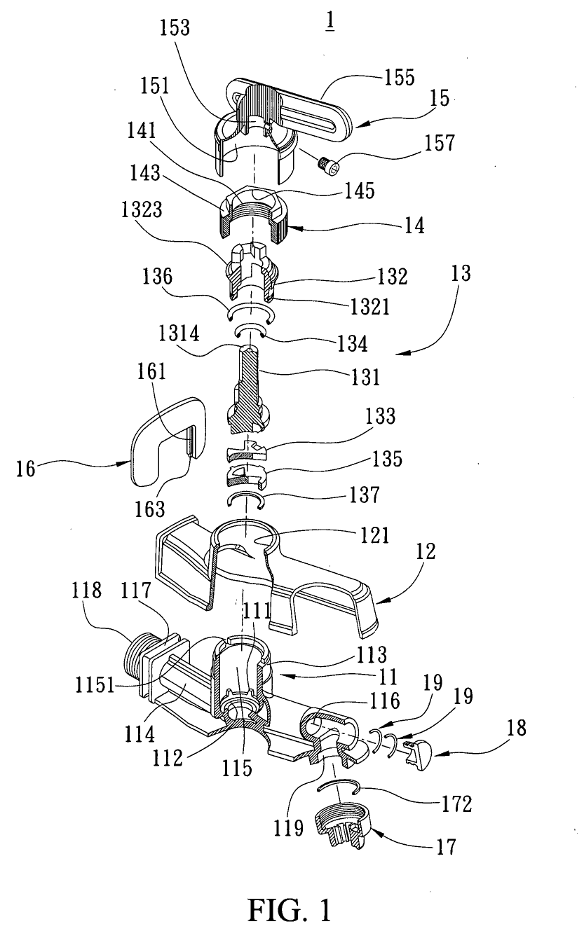

FIG. 1 through FIG. 6 are drawn to illustrate a first embodiment of the water tap in accordance with the present invention. Referring to FIG. 1, the water tap 1 of the present invention includes a main body 11; a decorative cap 12 for covering the main body 11; a water control assembly 13 disposed in the body 11, a fastening means 14 for fastening the water control assembly 13 and the decorative cap 12 to the main body 11, a rotation-driving member 15 connected to the water control assembly 13, a decorative panel 16 disposed on one side of the main body 11, and a regulator 17 disposed on the other side of the main body 11 at a position away from the decorative panel 11.

In the water tap 1 of the present invention, the main body 11 comprises a first positioning portion 111, a second positioning portion 112 disposed surrounding and beneath the first positioning portion 111; a first coupling portion 113 disposed at a position away from the first positioning portion 111 and above the main body 11; a first passageway 114 disposed at a position beneath the first positioning portion 111 and the second positioning portion 112; a cavity 115 disposed between the first positioning portion 111 and the first coupling portion 113; a second passageway 116 disposed above the first positioning portion 111 and the second positioning portion 112; a third positioning portion 117 disposed in the first passageway 114 at a position away from the first positioning portion 111; a third coupling portion 118 disposed on the third positioning portion 117 at a position away from the first positioning portion 111; and a fourth coupling portion 119 disposed to be perpendicular to the second passageway 116.

In this embodiment, the main body 1I may be but is not limited to, for example, an integrally formed tap body made by plastic and steel injection molding, wherein every component of the first positioning portion 111, the second positioning portion 112, the first coupling portion 113, the first passageway 114, the cavity 115, the second passageway 116, the third positioning portion 117, the third coupling portion 118, and the fourth coupling portion 119 are all integrally formed with the main body 11 by plastic and steel injection molding during the manufacturing process, thereby simplifying the steps of the manufacturing process while providing for a tap body having the characteristics of light weight, high rigidity and etching-resistance.

The first positioning portion 111 may comprise, for example, a plurality of rib portions 112 disposed to surround the upper portion of the second positioning portion 112, wherein the first positioning portion 111 and the second positioning portion 112 have a spacing gap existing therebetween. In this embodiment, the first positioning portion 111 comprises four pairs of rib portions altogether that are evenly disposed in the inner wall of the body 11, wherein intervals formed between each pair of rib portions are not the same but the interval formed between each corresponding pair of rib portions are identical. The second positioning portion 112 may be, for example, a ring-shaped groove disposed between the first passageway 114 and the second passageway 116. The first coupling portion 113 is provided with screw threads for fastening nuts and screws therein. The first passageway 114 is a cavity connected to an inlet pipe (not shown). The cavity 115 is a cavity connected to the first passageway 114 and has a pair of corresponding gaps 1151 formed on the top edge thereof. The second passageway 116 is a cavity connecting with the central cavity 115 that connects to the first passageway 114 for allowing water to flow therethrough from the main body 11 and is disposed to tilt slightly upwards with respect to the first passageway 114. The third positioning portion 117 may be, for example, a positioning groove for stopping the front of the third coupling portion 118. The third coupling portion 118 is connected to the inlet pipe and is provided with screw threads for fastening water pipes (not shown) thereto and serves as a water inlet port disposed at one end of the passageway, wherein the third positioning portion 117 may function as a stop for the screw threads to prevent the inlet pipe from passing over the third coupling portion 118 and further allow water to enter into the first passageway 114 through the inlet pipe. The fourth coupling portion 119 is disposed in the second passageway 116 close to either one of two exits at the end thereof and is provided with threads at the outer periphery thereof. The fourth coupling portion 119 is perpendicular to the second passageway 116 and functions as a water outlet port at one end of the passageway. In another embodiment, the fourth coupling portion 119 may be disposed at arbitrary positions opening downwardly from the second passageway 116. The included angle of the fourth coupling portion 119 and the second passageway 116 may be 90 degrees but is not limited thereto.

The decorative cap 12 has a shape corresponding to the plastic cover of the main body 11 for covering on the main body 11 while exposing the cavity 115, thereby strengthening the structure of the main body 11 and providing an aesthetically-pleasing appearance. The decorative cap 12 comprises a connecting hole 121 corresponding to the cavity 115, and may further comprise a protective layer on the surface thereof. For example, the surface of the decorative cap 12 may be coated with stainless chromium, titanium, chromium, lacquer and ceramic materials as a protective layer. Further, the third positioning portion 117 and the fourth positioning portion 118 are exposed from the decorative cap 12 for allowing the main body 11 to connect with the inlet pipe.

The water control assembly 13 comprises a core shaft 131 disposed in the cavity 115, a core shaft cap 132 disposed to partly cover the periphery of the core shaft 131, a first water control member 133 adapted to correspond to the core shaft 131, an O-shaped ring 134 disposed to cover on the core shaft 131, and a second water control member 135 fixedly disposed on the bottom of the first water control member 133 and corresponding to the first positioning portion 111.

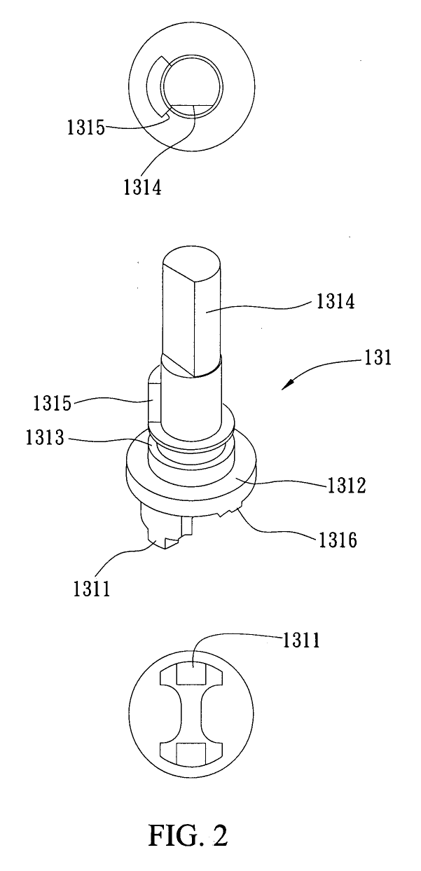

As shown in FIG. 2, in this embodiment, the core shaft 131 comprises a first limiting portion 1311 disposed on the bottom thereof, a ring-shaped step portion 1312 connected to the first limiting portion 1311, a ring-shaped cavity 1313 disposed on top of the ring-shaped stair portion 1312, a first fastening portion 1314 disposed on the top thereof for connecting with the rotation-driving member 15, a rotation-limiting portion 1315 disposed between the ring-shaped cavity 1313 and the first fastening portion 1314, and a protrusive portion 1316 extending downwardly from the lower periphery of the ring-shaped step portion 1312. The first limiting portion 1311 may be a protrusion and there is a pair of such protrusions provided in this embodiment. The ring-shaped step portion 1312 is a protrusion having a plane surface larger than the first limiting portion 1311, the ring-shaped cavity 1313, and the rotation-limiting portion 1315. The ring-shaped cavity 1313 is adapted to receive the O-shaped ring 134 therein (as shown in FIG. 1). The first fastening portion 1314 is a base body in a shape close to a semi-cylindrical structure and has a peripheral surface and a securing plane surface connected to the peripheral surface thereof. Further, the first fastening portion 1314 may be a U-shaped slot, a protruding pin, or any other equivalent structures as long as it can move relative to the rotation-driving member 15. The rotation-limiting portion 1315 is adapted to cover the core shaft cap 132 and is in the shape of a cylinder with a height of approximately 2 mm, such that the rotation-limiting portion 1315 has better resistance to wear, longer lifespan of usage, and stronger leak-proof ability over prior art techniques that are typically built to have a height of merely 0.75 mm. The protrusive portion 1316 is adapted to correspond to the opening gap 1151 for correspondingly coupling to the opening gap 1151, thereby fastening the core shaft 131 to the main body to keep it from rotating.

The core shaft cap 132 is a hollow cap having a ring-shaped cavity 1321 disposed in the lower periphery thereof, and a ring-shaped step portion 1323 which is a protrusion disposed above the ring-shaped cavity 1321 for facilitating installation of the O-shaped ring 136.

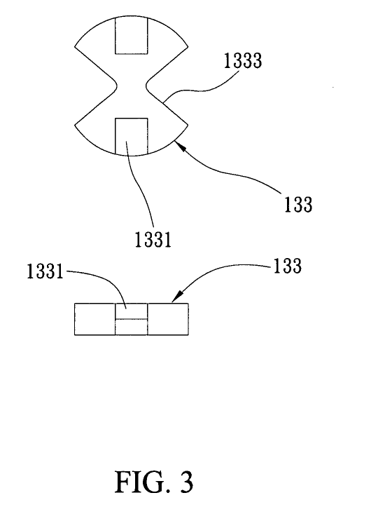

Referring to FIG. 3, the first water control member 133 may be, for example, a planar body in a connective dual-fan shape comprising a pair of third limiting portions 1331 corresponding to the pair of first limiting portions 1311 and a water passing portion 1333 disposed at one side of each third limiting portion 1331. In this embodiment, the first water control member 133 is a precision ceramic planar body having strong rigidity and durability to wearing. The third limiting portion 1331 may be, for example, a rectangular groove corresponding to the first limiting portion 1311, or any equivalent structures capable of connecting or coupling the third limiting portion 1331 to the first limiting portion 1311. The water-passing portion 1333 may be an open gap in the shape of a fan.

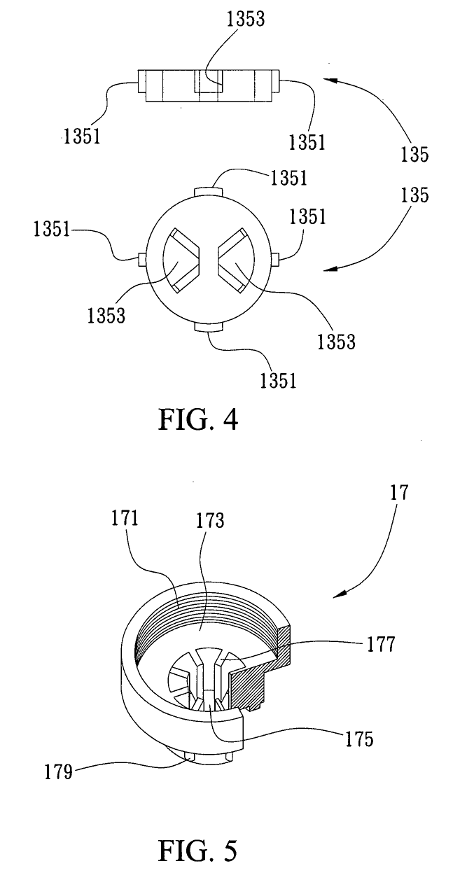

As shown in FIG. 4, the second water control member 135 may be, for example, a round shaped planar body having a size slightly smaller than the cavity 115, and comprising a plurality of fourth positioning portions 1351 disposed at the outer periphery thereof, and a plurality of water-passing portions 1353 disposed to pass through the second water control member 135. In this embodiment, the second water control member 135 is a precision ceramic planar body having high rigidity and durability to wearing. The fourth limiting portion 1351 may be, for example, a protrusion corresponding to the first limiting portion 1311 and has four fourth positioning portions 1351 evenly disposed at the outer periphery thereof, wherein the adjacent fourth positioning portions 1351 have different shapes and sizes from one another.

The fastening means 14 comprises a second coupling portion 141 corresponding to the first coupling portion 113, a second limiting portion 143 connected to the second coupling portion 141, and a penetrable portion 145 for allowing the core shaft 131 to pass therethrough. The fastening means 14 may be a securing nut made of plastic and the second limiting portion 143 may be screw threads disposed to surround the inner wall thereof. The second limiting portion 143 is a step portion disposed to surround the inner wall of the fastening means 14 to abut against the ring-shaped step portion 1323, thereby restricting movement of the core shaft 131 in the penetrable portion 145 and concurrently enabling the water control assembly 13 and the decorative cap 12 to be fastened to the main body 11, wherein the penetrable portion 145 may be an opening.

The rotation-driving member 15 is adapted to connect with the core shaft 131 and cover the cavity 115. The rotation-driving member 15 may be, for example, a plastic handle and may be formed with a protective layer, comprising: a cavity 151 for receiving the fastening means 14 therein, a second fastening portion 153 disposed above the cavity 151, and a driving portion 155 connected to the second fastening portion 153. The cavity 151 may be an opening having a slightly larger size than the fastening means 14. The second fastening portion 153 is a cavity for correspondingly coupling to the first fastening portion 1314, for example, a groove having a shape similar to a semi-cylindrical structure comprising a peripheral inner wall and a plane securing inner wall connected to the peripheral inner wall. The driving portion 155 may be, but is not limited to, for example, a handle or other equivalent structures in various shapes.

The decorative panel 16 is a panel body in the shape of, for example, an inverted sink and comprises a fifth positioning portion 161 corresponding to the third positioning portion 117 and a sixth positioning portion 163 connected to the two ends of the fifth positioning portion 161. The fifth positioning portion 161 may be, for example, a protruding rib disposed in the inner wall of the decorative panel 16, and the sixth positioning portion 163 protrudes more from the inner wall of the decorative panel 16 than the fifth positioning portion 161 so as to block the bottom surface of the third positioning portion 117 for covering up possible marring caused thereto during installation. Optionally, the decorative panel 16 may well be omitted in other embodiments.

The regulator 17 may be, for example, a regulator valve, a throttle value, a filter or other equivalent structures. In this embodiment, as shown in FIG. 5, the regulator 17 comprises a fixing portion 171 surrounding the inner periphery thereof, a step portion 173 connected to the fixing portion 171, a plurality of water-passing portions 175 penetrating through the step portion 173, a plurality of spacing portions 177 separating each of the water-passing portions 175 from one another, and a plurality of turning-assist portions 179 surrounding the outer periphery thereof. The fixing portion 171 is adapted to correspond to the threads of a screw portion formed on the outer periphery of the fourth coupling portion 119. The step portion 173 is adapted to abut against the bottom of the fourth coupling portion 119. The water-passing portions 175 are, but are not limited to, fan-shaped openings in this embodiment; other equivalent structures may well be employed depending on the function of the regulator 17 for the purpose of adjusting, sputtering, filtering or restricting the flow of water. The spacing portions 177 may be, for example, fins that are disposed to correspond to the water-passing portions 175. The turning-assist portions 179 may be, for example, protruding ribs for enabling a human user to manually adjust/turn the regulator 17 by hand and also facilitating assembly and disassembly of the regulator 17. Optionally, the regulator 17 may well be omitted in other embodiments.

Further, a cap member 18 may be disposed at an end portion of the second passageway 116 away from the first passageway 114 on the main body 11, and a leak-proof member 19 may be disposed at a position between the cap member 18 and an end portion of the second passageway 116. The cap member 18 may be, for example, a plastic cover adapted to prevent water from leaking at a front side of the tap/faucet 1, and the leak-proof member 19 may be, for example, an O-shaped ring disposed in the cap member 18, such that the surface of the cap member 18 can be more tightly sealed with the end portion of the second passageway 116, preventing water from leaking at the front side of the tap 1. The cap member 18 and the leak-proof member 18 may be, but are not limited to, plastic sealing components as employed in this embodiment. Similarly, the cap member 18 and the leak-proof member 19 may well be omitted in other embodiments, or other equivalent structures may be employed to provide a sealing effect, such as welding the end portion of the second passageway 116 by a high frequency welding technique or sealing the second passageway 116 by attaching a similar sealing component thereto.

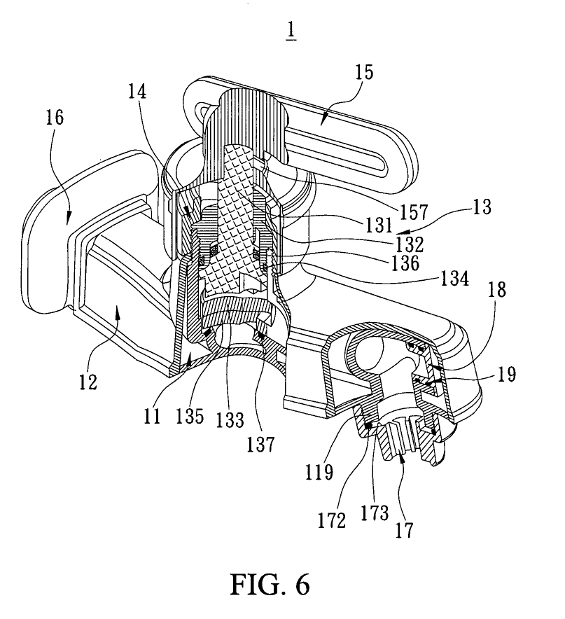

In assembling the tap 1, the O-shaped ring 137, as illustrated in FIG. 1, is disposed on the second positioning portion 112, and the second water control member 135 is fixed by the first positioning portion 111 via the cavity 115. The first water control member 133 is first disposed on the second water control member 135 and the core shaft 131 is then disposed therein. Alternatively, the third limiting portion 1331 is disposed corresponding to the first limiting portion 1311 and then the first water control member 133 and the core shaft are disposed into position. The core shaft cap 132 penetrates through the core shaft 131 and the first fastening portion 1314 to fasten the rotation-limiting portion 1315 by the O-shaped ring 134 disposed on the ring-shaped cavity 1313, thereby fastening the core shaft cap 132 to the core shaft 131. The cap member 18 and the leak-proof member 19 are fastened to one side of the main body 11 before the decorative cap 12 is covered thereon, preventing water from leaking at the front side of the faucet 1. The penetrable portion 145 of the fastening member 14 penetrates through the core shaft 131, and the second coupling portion 141 is correspondingly coupled to the first coupling portion 113, thereby fastening the water control assembly 13 and the decorative cap 12 to the main body 11. The second fastening portion 153 of the rotation-driving member 15 is covered on the first fastening portion 1314 of the core shaft 131. The decorative panel 16 is fastened to the third positioning portion 117. The regulator 17 is locked in position via the threaded groove formed at the outer periphery of the fixing portion 171 by operating the turning-assist portion 179 thereof. A washer 172, which is shown in FIG. 1 and FIG. 6, may be disposed between the step portion 173 and the fourth coupling portion 119. Finally, referring to the upper portion of the tap, a fastening member 157 may be optionally employed to strengthen the grip between the core shaft 131 and the rotation-driving member 15. The assembled faucet 1 is depicted in FIG.

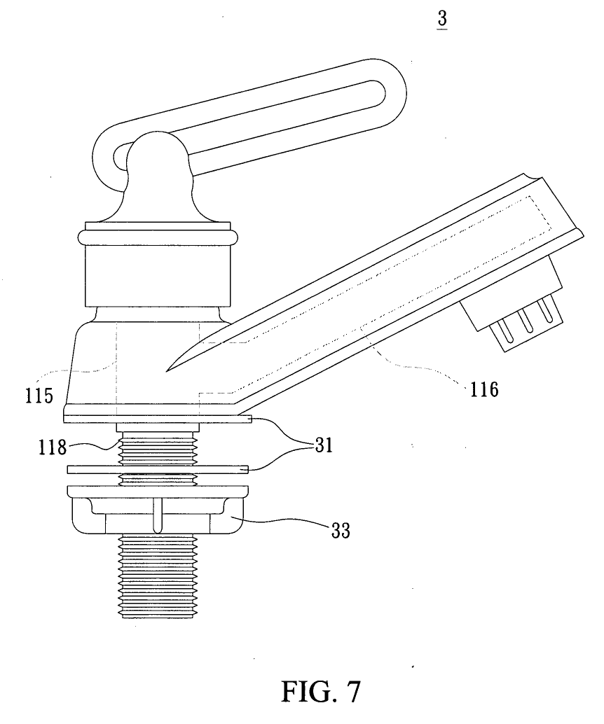

FIG. 7 shows a second preferred embodiment of the faucet assembly in accordance with the present invention. The main difference between the second preferred embodiment and the first embodiment is that the first embodiment is a straight bolt type faucet for being installed on the wall surface directly, while the second embodiment is an upright bolt type faucet that is typically installed in face-wash basins, hand-wash basins, kitchens and toilet/shower apparatuses. The components employed in this second embodiment are substantially the same as those used in the first embodiment, therefore, like components and structures are omitted herein for brevity.

As shown in FIG. 7, the faucet 3 in this embodiment has only one water passageway similar to the second passageway 116 in the first embodiment comprising the cavity 151 and the third coupling portion 118. Also, the third coupling portion 118, which is perpendicular to the cavity 151, is integrally formed with the cavity 151 for connecting with the water inlet pipe and functions as a water inlet port disposed at one end of the second passageway 116.

The faucet 3 may further comprise two stopping pieces 31 disposed to cover on the third coupling portion 118, and an outer positioning member 33 disposed under the stopping piece 31, wherein the stopping piece 31 may be a plastic washer. The outer positioning member 33 may be a block body made of plastic material and formed with a hole for assembling the third coupling portion 118 to an installation surface on face-wash basins, hand-wash basins, kitchens and toilet/shower apparatuses.

In conclusion, the water tap of the present invention is characterized in that most of its components can be assembled at one time, and each component thereof is easily manufactured and processed to save costs in materials and assembly, such that drawbacks of prior techniques in which high material costs due to the use of copper, difficulties in the manufacturing process and subsequent processing and inconvenient assemble due to different components involved, can be eliminated. Moreover, the first and second water control members are individual components specially designed and fabricated to have strong rigidity and wear-resistance, and also the structure of the core shaft is improved to have better durability for an extended usage life.

While illustrative embodiments are provided in the above description, such are for illustration only of the principles and functions of the present invention and such mare not to be construed restrictively. Numerous modifications and variations of the present invention will be obvious to those skilled in the art and are covered by the following claims.

What is claimed is:

1. A water tap, comprising:
a main body comprising a passageway, a water inlet port and a water outlet port disposed on the two ends of the passageway respectively, a first positioning portion disposed in the passageway, a first coupling portion disposed at a position away from the first positioning portion and above the main body, and a receiving portion disposed at a position between the first positioning portion and the first coupling portion;
a decorative cap for covering the main body and exposing the receiving portion;
a water control assembly comprising a core shaft disposed in the receiving portion and having a first limiting portion, a first water control member configured to correspond to the first limiting portion, and a second water control member fixedly disposed at the bottom of the first water control member and corresponding to the first positioning portion;
a fastening means comprising a second coupling portion corresponding to the first coupling portion, a second limiting portion connected to the second coupling portion, and a penetrable portion for allowing the core shaft to pass therethrough, wherein the second limiting portion is adapted to restrict movement of the core shaft in the penetrable portion and concurrently enable the water control assembly and the decorative cap to be fastened to the main body; and
a rotation-driving member for sleeving the core shaft and covering the receiving portion.

2. The water tap according to claim 1, wherein the main body is a tap body integrally formed by plastic and steel injection molding.

3. The water tap according to claim 1, wherein the first positioning portion comprises a plurality of protruding ribs.

4. The water tap according to claim 1, wherein the first coupling portion comprises screw threads.

5. The water tap according to claim 1, wherein the receiving portion is a cavity.

6. The water tap according to claim 1, wherein the main body further comprises a second positioning portion disposed to surround and be beneath the first positioning portion; a first passageway disposed at a position beneath the first positioning portion and the second positioning portion; a second passageway disposed above the first positioning portion and the second positioning portion; a third positioning portion disposed in the first passageway at a position away from the first positioning portion; a third coupling portion disposed on the third positioning portion at a position away from the first positioning portion; and a fourth coupling portion disposed to be perpendicular to the second passageway.

7. The water tap according to claim 1, wherein the decorative cap is a plastic cover.

8. The water tap according to claim 1, wherein the decorative cap comprises a connecting hole corresponding to the receiving portion.

9. The water tap according to claim 1, wherein the water control assembly further comprises a core shaft cover disposed to partly cover periphery of the core shaft.

10. The water tap according to claim 1, wherein the core shaft comprises a first limiting portion disposed at the bottom thereof, a ring-shaped step portion connected to the first limiting portion, a ring-shaped cavity disposed at the top of the ring-shaped step portion, a first fastening portion disposed at the top thereof for connecting with the rotation-driving member, a rotation-limiting portion disposed between the ring-shaped cavity and the first fastening portion.

11. The water tap according to claim 1, wherein the first and second water control members are ceramic planar bodies.

12. The water tap according to claim 1, wherein the first water control member comprises second and third limiting portions corresponding to the first limiting portions, and a water-passing portion disposed at one side of each of the third limiting portion.

13. The water tap according to claim 1, wherein the second water control member comprises a fourth positioning portion disposed at an outer periphery thereof, and water passing portions disposed to penetrate through the second water control member.

14. The water tap according to claim 1, wherein the fastening means are screw nuts.

15. The water tap according to claim 1, wherein the second coupling portion comprises screw threads disposed to surround the inner wall of the fastening means.

16. The water tap according to claim 1, wherein the second limiting portion is a step portion disposed to surround the inner wall of the fastening means.

17. The water tap according to claim 1, wherein the penetrable portion is an opening.

18. The water tap according to claim 1, wherein the rotation-driving member comprises a cavity for receiving the fastening means therein, a second fastening portion disposed above the cavity, and a driving portion connected to the second fastening portion.

19. The water tap according to claim 1, further comprising a decorative panel disposed on one side of the main body, and a regulator disposed on the other side of the main body at a position away from the decorative panel.

20. The water tap according to claim 1, further comprising a lid member disposed at an end portion of the main body, and a leak-proof member disposed between the lid member and the end portion of the passageway.
